(19) United States
(12) Patent Application Publication
(10) Pub. No.: US 2016/0141123 A1
(43) Pub. Date: May 19, 2016

(54) SYNTHETIC FAULT REMOTE DISCONNECT FOR A BRANCH CIRCUIT

(71) Applicant: SCHNEIDER ELECTRIC USA, INC., Palatine, IL (US)

(72) Inventors: Kevin M. JEFFERIES, Raleigh, NC (US); Benjamin W. EDWARDS, Rolesville, NC (US); Richard G. SPANGENBERG, Raleigh, NC (US); Richard K. WEILER, Raleigh, NC (US); Matthew L. WHITE, Raleigh, NC (US)

(73) Assignee: SCHNEIDER ELECTRIC USA, INC., Schaumburg, IL (US)

(21) Appl. No.: 14/898,800

(22) PCT Filed: Jun. 21, 2013
(86) PCT No.: PCT/US13/47095

§ 371 Date: Dec. 16, 2015

(51) Int. Cl. H01H 9/54; H02H 3/16; H02H 3/08; H02H 5/04

(52) U.S. Cl. CPC H01H 9/54; H02H 5/041; H02H 3/16; H02H 3/08

(57) ABSTRACT

A synthetic fault signal generator assembly is remotely located on a branch circuit downstream from a circuit breaker protecting a load. The synthetic fault signal generator assembly is configured to detect an improper circuit condition that is not independently detected, detectable, or actionable by the circuit breaker such as, for example, a load or outlet receptacle specific problem that can lead to equipment damage or property damage if not mitigated. In response to the improper circuit condition being detected, the synthetic fault signal generator assembly generates a synthetic fault signal, which causes the circuit breaker to trip. The synthetic fault signal generator assembly can inject the synthetic fault signal into the branch circuit to provide the synthetic fault signal to the circuit breaker.

### FIELD OF THE INVENTION

The present disclosure relates generally to protection systems for electrical circuits and, more particularly, to a synthetic fault signal generator for extending the protection functions of an electronic circuit breaker to cover improper circuit conditions that are not independently detected, detectable, or actionable by the circuit breaker.

### BACKGROUND

Circuit breakers placed at the upstream side of a circuit branch are designed to protect an electrical circuit from a fixed set of conditions. This is typically accomplished by removing power from the downstream circuit in response to a detected condition (e.g., by activating a movable contact to break continuity of the conductor), also known as tripping. Basic circuit breaker protection functions include protection for over-current and short circuit current conditions. Electronic circuit breakers, such as Arc Fault Interrupters (AFI) or Ground Fault Interrupters (GFI) or combinations thereof, sense and monitor the current profile, or signature, drawn by the downstream load, and if the current exhibits certain suspect signatures, the breaker protects the circuit by tripping.

Significantly, however, a number of problems can occur on the branch circuit, what are not detected, detectable, or actionable by the circuit breaker. These conditions can lead to equipment damage, or even property damage through fire. For example, fractional horsepower motors are used in a variety of residential loads such as attic fans, compressor pumps, sump pumps, well pumps, and garage door openers. A gradual rise in temperature at a motor, or a badly wired or corroded outlet downstream from the breaker, may lead to a fire. These conditions will not be detected by the circuit breaker at the branch circuit level. While thermal cutoff switches have been previously employed in electrical devices such as motors to augment the protection provided by a circuit breaker, such thermal cutoff switches can be prone to failure and cannot protect against hazardous, non-thermal branch circuit or load specific conditions.

### BRIEF SUMMARY

According to aspects of the present disclosure, a synthetic fault signal generator assembly is remotely located on a branch circuit downstream from an electronic circuit breaker protecting a load. The circuit breaker is configured to trip in response to one or more circuit-breaker-trip conditions. The synthetic fault signal generator assembly is configured to detect an improper circuit condition that may not be detected, dectectable, or actionable by the electronic circuit breaker such as, for example, a load or outlet receptacle specific problem that can lead to equipment damage or property damage if not mitigated. That is, the improper circuit conditions are different from each of the one or more circuit-breaker-trip conditions. The synthetic fault signal generator assembly can include a sensor configured to detect various conditions, potentially affecting the branch circuit, including current conditions, temperature conditions, pressure conditions, vibration conditions, light conditions, sound conditions, liquid conditions, gas conditions, and/or other load or outlet receptacle specific conditions. The improper circuit condition is not detected by the circuit breaker or appears to be benign, and thus would not ordinarily cause the electronic circuit breaker to trip.

In response to the improper circuit condition being detected, the synthetic fault signal generator assembly generates a synthetic fault signal that resembles or mimics a fault signal with a current signature that the electronic circuit breaker will recognize. The synthetic fault signal generator assembly can inject the synthetic fault signal into the branch circuit to cause the circuit breaker to trip. In one implementation, the synthetic fault signal can have a signature that is indicative of the one or more circuit-breaker-trip conditions that cause the electronic circuit breaker to trip. In another implementation, the synthetic fault signal can have a unique signature that the circuit breaker is configured to detect via a firmware update.

The synthetic fault signal generator assembly can thus provide additional protection for hazardous conditions that are not otherwise protected by the circuit breaker. This can be done without the need to run additional conductors between the remote location of the synthetic fault signal generator assembly and the location of the circuit breaker. As such, the synthetic fault signal generator assembly provides a simple and low cost solution to extend the protection functions of the circuit breaker to cover improper conditions that may be harmful to specific loads.

The foregoing and additional aspects and implementations of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the present disclosure will become apparent upon reading the following detailed description and upon reference to the drawings.

FIG. 1 is a functional diagram of an exemplary synthetic fault remote disconnect system according to aspects of the present disclosure.

FIG. 2 is a diagram of an exemplary load having a synthetic fault signal generator assembly embedded within an electrical power plug of the load according to aspects of the present disclosure.

FIG. 3 is a flowchart of a process for protecting an electrical device according to aspects of the present disclosure.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the invention is to cover all modifications, equivalents, and alternatives falling within the scope of the present disclosure.

### DETAILED DESCRIPTION

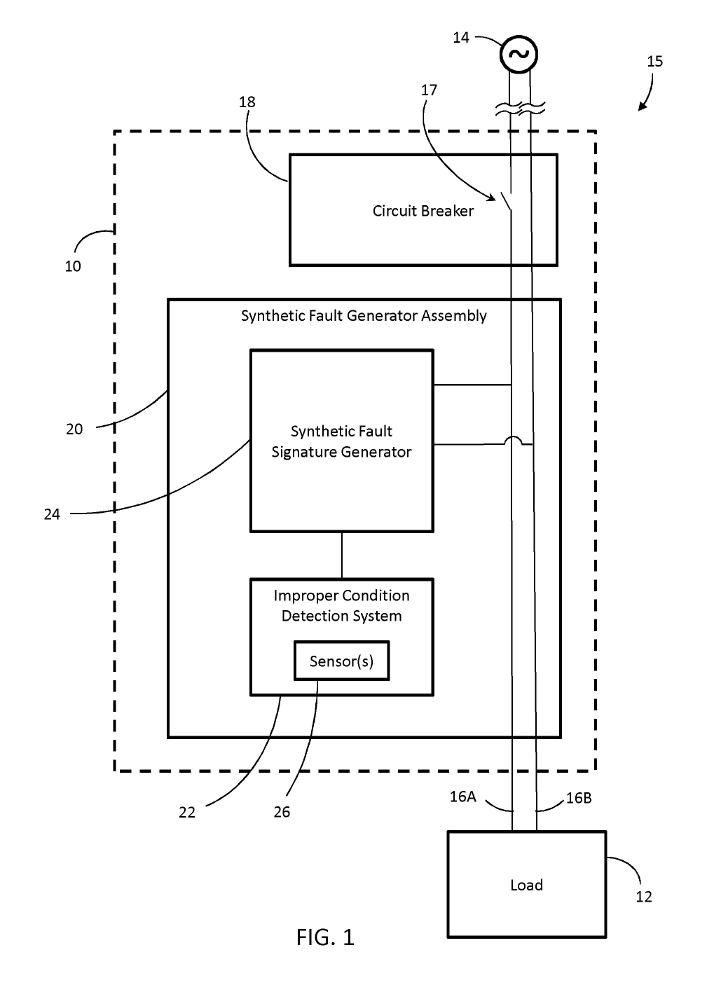

FIG. 1 illustrates a functional block diagram of a synthetic fault remote disconnect system 10 for protecting a load 12 receiving power from an electrical power source 14 according to aspects of the present disclosure. The synthetic fault remote disconnect system 10 is illustrated on a branch circuit 15 of an electrical distribution system in FIG. 1; however, this configuration is merely exemplary, and is intended to facilitate understanding of the synthetic fault remote disconnect system 10. The present disclosure is not limited to the particular configuration illustrated in FIG. 1 as will be apparent from the descriptions below.

The branch circuit 15 illustrated in FIG. 1 can be part of a larger electrical distribution system, which can include one or more main distribution circuit breakers, feeder circuit breakers, branch circuit breakers, and/or other electrical equipment. According to some aspects, the electrical distribution system can be an alternating current (AC) electrical distribution system, which can distribute a single phase or multiple phase (e.g., two or three) of electricity on the branch circuit 15 from the electrical power source 14 to the load 12. In the particular example illustrated in FIG. 1, the branch circuit 15 includes a line conductor 16A and a neutral conductor 16B for conducting an AC electrical power between the electrical power source 14 and the load 12.

Non-limiting examples of a load 12 on a branch circuit 15 can include devices such as motors, computers, heaters, lighting, and/or other electrical equipment. As an additional non-limiting example, the load 12 can be a device that includes a fractional horsepower motor such as an attic fan, a compressor pump, a sump pump, a well pump, or a garage door opener.

The synthetic fault remote disconnect system 10 includes an electronic circuit breaker 18 (i.e., the circuit breaker defining the branch in FIG. 1) and a synthetic fault signal generator assembly 20 remotely located downstream of the circuit breaker 18. The circuit breaker 18 protects the load 12 by tripping in response to one more circuit-breaker-trip conditions (i.e., fault or abnormal current conditions). More particularly, the electronic circuit breaker 18 is configured to monitor the current to the downstream load 12 on the conductors 16A, 16B for one or more fault signals that indicate the occurrence of the one or more circuit-breaker-trip conditions. In response to a circuit-breaker-trip condition being detected, the circuit breaker 18 disconnects the load 12 from the electrical power source 14. For example, the circuit breaker 18 can include one or more contacts 17 that can be actuated to open and interrupt the circuit conducting power between the electrical power source 14 and the load 12.

According to aspects of the present disclosure, the electronic circuit breaker 18 can be configured as an arc fault circuit interrupter (AFCI), a ground fault interrupter (GFI), or a combination thereof. Accordingly, the one or more circuit-breaker-trip conditions can include, for example, a short-circuit trip condition(s), a current overload trip condition(s), a ground fault trip condition(s), and/or an arc-fault trip condition(s). The short-circuit trip condition can result when the line conductor 16A contacts the neutral conductor 16B (or another line conductor in systems employing multiple line conductors), or if there is a break in a conductor 16A, 16B in the branch circuit 15. The current overload trip condition results when the current exceeds a continuous rating of the circuit breaker 18 for a time interval determined by a trip current. The ground fault trip condition is created by an imbalance of currents flowing between the line conductor 16A and the neutral conductor 16B, which could be caused by a leakage current or an arcing fault to ground. The arc-fault trip condition is commonly defined as current through ionized gas occurring, for example, at a faulty contact or connector, between two conductors 16A, 16B supplying a load 12, or between a conductor (e.g., the conductor 16A) and ground. There are many conditions that may cause an arc-fault trip condition such as, for example, corroded, worn or aged wiring, connectors, contacts or insulation, loose connections, wiring damaged by nails or staples through the insulation, and electrical stress caused by repeated overloading, lightning strikes, etc.

As described above, the electronic circuit breaker 18 protects against a set of specific problems characterized by the one or more circuit-breaker-trip conditions. Notably, however, the circuit breaker 18 cannot by itself protect against all problems that can occur on the branch circuit 15. For example, an HVAC blower motor is capable of continuous operation (e.g., if a control relay fails) that may not be detected by the circuit breaker 18 as a harmful condition but will eventually cause a temperature aberration and excessive energy use. Left unchecked, such temperature aberrations and excessive energy use can cause substantial property damage, present fire hazards, and create potentially hazardous conditions for an operator of the load 12. As additional examples, an electronic circuit breaker 18 cannot detect a water leak, an over-temperature condition, or a glowing connection in an electrical outlet (not shown) on the branch 15.

To address this gap in protection, the synthetic fault signal generator assembly 20 is configured to detect one or more improper circuit conditions and, in response thereto, cause the electronic circuit breaker 18 to trip. The improper circuit conditions are conditions specific to the load 12, conditions specific to other electrical devices downstream of the circuit breaker 18 such as an outlet receptacle (not shown), or conditions in the immediate environment of the branch circuit 15 which may lead to equipment damage or property damage if not mitigated. As described above, the improper circuit conditions are conditions that may not be detected, detectable, or actionable by the electronic circuit breaker 18. That is, the improper circuit conditions appear to the circuit breaker 18 to be benign, and thus would not ordinarily cause the circuit breaker 18 to trip.

The synthetic fault signal generator assembly 20 includes an improper condition detection system 22 communicatively coupled to a synthetic fault signal generator 24. The detection system 22 detects the occurrence of the one or more improper circuit conditions and, upon detecting the occurrence of an improper circuit condition, provides a trigger signal to the synthetic fault signal generator 24. In response to the trigger signal, the synthetic fault signal generator 24 generates a synthetic fault signal that causes the electronic circuit breaker 18 to trip.

The improper condition detection system 22 includes one or more sensors 26 configured to detect the one or more improper circuit conditions. The one or more sensors 26 are located in, on, and/or proximate to the load 12 (or, as described below, other electrical device downstream of the circuit breaker 18 such as an outlet receptacle). The location of the one or more sensors 26 with respect to the load 12 can assist in the detection of improper circuit conditions that may not be detected by the remotely located upstream circuit breaker 18.

The improper circuit conditions can include current condition(s), thermal condition(s), pressure condition(s), vibration condition(s), light condition(s), sound condition(s), liquid condition(s), gas condition(s), and/or other load, outlet receptacle, or branch environment conditions. Accordingly, the one or more sensors 26 can be configured to detect characteristics of the foregoing conditions. For example, the sensor(s) 26 can be configured to determine whether an improper circuit condition has occurred based on a detected magnitude, intensity, frequency, duration, rate of change, volume, and/or presence or absence of a characteristic related to the one or more improper circuit conditions.

It is contemplated that, according to some optional aspects, the improper condition detection system 22 can include additional circuitry configured to process characteristics detected by the sensor(s) 26 (e.g., measured current values, temperature values, pressure values, light values, sound values, liquid values, gas values, etc.) to determine whether an improper circuit condition has occurred. For example, the improper condition detection system 22 can include analog components and/or digital components (e.g., controller(s) or processor(s)) for determining when a characteristic detected by the sensor(s) 26 is outside of a predetermined range of threshold values (e.g., above and/or below one or more threshold values).

In response to a trigger signal being received from the detection system 22 (i.e., in response to an improper circuit condition being detected by the detection system 22), the synthetic fault signal generator 24 generates a synthetic fault signal. The synthetic fault signal is communicated to the circuit breaker 18 over the conductors 16A, 16B by injecting the synthetic fault signal into the branch circuit 15. The synthetic fault signal causes the electronic circuit breaker 18, monitoring the downstream current on the branch circuit 15, to trip. The synthetic fault signal generator assembly 20 can thus provide additional protection for hazardous conditions that are not otherwise protected by the circuit breaker 18 without the need to run additional conductors between the remote location of the synthetic fault signal generator assembly 20 and the location of the upstream circuit breaker 18.

According to aspects of the present disclosure, the synthetic fault signal has a signature that resembles or mimics the signature of a fault signal that the electronic circuit breaker 18 is configured to recognize as indicative of the circuit-breaker-trip condition(s). As such, the synthetic fault remote disconnect system 10 of the present disclosure can be retrofitted into existing infrastructure with minimal cost by making use of the existing functions of the circuit breaker 18. The synthetic fault remote disconnect system 10 thus provides a simple and low cost solution to extend the protection functions of the circuit breaker 18 to cover conditions that are harmful to specific loads 12 (and may not otherwise be protected against by the circuit breaker 18).

In one non-limiting implementation, the electronic circuit breaker 18 can be configured to detect arc fault trip conditions by measuring the spectral components in the signature waveforms of the monitored downstream current (i.e., the current on the conductors 16A, 16B). If sufficient spectral content is present in certain frequency bands, this can be taken into account and used to detect the one or more circuit-breaker-trip conditions (e.g., an arc fault), for example, using a signal processing detection algorithm. In this way, the circuit breaker 18 can be configured to protect the branch circuit 15 from a fixed set of circuit-breaker-trip conditions (i.e., based on the spectral content of signature waveforms known to be indicative of the circuit-breaker-trip conditions).

In response to an improper circuit condition being detected by the detection system 22, the fault signal generator 24 is configured to generate a synthetic fault signal that includes spectral content in frequency band(s) that the circuit breaker 18 is configured to recognize as a fault signal indicative of a circuit-breaker-trip condition. For example, the synthetic fault signal generator 24 can be configured to drive a switching shunt with a pulse width modulated signal across the conductor(s) 16A, 16B to produce the synthetic fault signal resembling an arc fault signature. Monitoring the downstream load current on the branch circuit 15, the circuit breaker 18 receives the synthetic fault signal injected onto the conductors 16A, 16B of the branch circuit 15, recognizes the harmonic content of the synthetic fault signal as indicative of one of the circuit-breaker-trip condition(s), and disconnects the load 12 from the electrical power source 14.

While the above example is described in the context of an electronic circuit breaker 18 recognizing signals having signatures indicative of arc faults, the electronic circuit breaker 18 can additionally and/or alternatively be configured to detect ground fault trip conditions. In such embodiments, the synthetic signal fault generator 24 can be additionally and/or alternatively configured to generate synthetic fault signals that resemble or mimic the fault signals indicative of ground fault trip conditions. For example, the synthetic fault signal generator 24 can generate a synthetic fault signal that resembles or mimics a ground fault tip condition by leaking current to a capacitor from one of the conductors 16A, 16B in response to the trigger signal. The resulting imbalance of current on the conductors 16A, 16B can be detected by the circuit breaker 18 as indicative of a ground fault trip condition and, thus, cause the circuit breaker 18 to trip.

As the above examples demonstrate, the synthetic fault signals can be recognized based on harmonic content in certain frequency bands and/or a current imbalance and do not require high levels of power dissipation to be recognized. Accordingly, the synthetic fault signals can be safely generated without using high magnitude electrical currents and, thus, pose no electrical stress threats to the system 10. It is contemplated that, according to additional and/or alternative aspects of the present disclosure, the synthetic fault signal can have a unique signature that the circuit breaker 18 is configured to detect via a firmware update.

As described above, the synthetic fault signal generator assembly 20 is remotely located downstream of the circuit breaker 18. According to some aspects of the present disclosure, the synthetic fault signal generator assembly 20 can be located in, on, or proximate to the load 12. The location of the synthetic fault signal generator assembly 20 with respect to the load 12 can assist in the detection of improper circuit conditions that are not detected, detectable, or actionable by the remotely located circuit breaker 18.

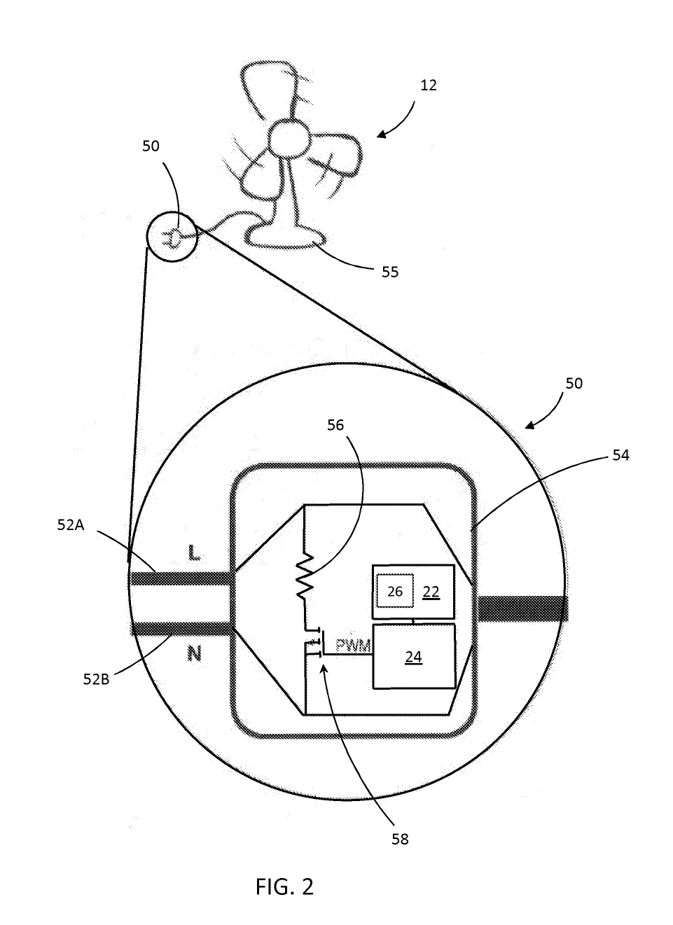

In some implementations, the synthetic fault signal generator assembly 20 can be embedded within a power plug of the load 12. For example, FIG. 2 illustrates an exemplary load 12 including a power plug 50 in which a synthetic fault signal generator assembly is embedded. The power plug 50 includes a live prong 52A and a neutral prong 52B for electrically coupling to the line conductor 16A and the neutral conductor 16B, respectively, of the branch circuit 15. The plug 50 further includes a plug housing 54 in which the improper condition detection system 22 and the synthetic signal generator 24 are located. In the illustrated example, the live prong 52A is coupled to the synthetic fault signal generator 24 via a resistor 56 and a transistor 58 for generating a pulse-width modulated synthetic fault signal. The neutral prong 52B is also coupled to the synthetic fault signal generator 24 via the transistor 58. The plug housing 54 can further include the one or more sensors 26 of the improper condition detection system 22.

In other implementations, a part or the entire synthetic fault signal generator assembly 20 can be located in, on, or proximate to other portions of the load 12 (i.e., external to an electrical plug housing). For example, the synthetic fault signal generator assembly 20 can be partially or entirely located in, on, or proximate to a housing 55 of the load 12 device, or an AC power adapter on a power cord (not shown).

While the synthetic fault signal generator assembly 20 (or the one or more sensors 26 thereof) have been described as being located in, on, or proximate to a load 12 according to some aspects of the present disclosure, it is contemplated that, according to additional or alternative aspects of the present disclosure, the synthetic fault signal generator assembly 20 can be located in, on, or proximate to other electrical equipment downstream of a circuit breaker 18 in an electrical distribution system. For example, the synthetic fault signal generator assembly 20 can be located in, on, or proximate to an outlet receptacle configured to provide electrical power to the load 12. In such embodiments, the improper circuit conditions can include outlet receptacle specific problems (e.g., glowing connections) that can lead to equipment damage or property damage if not mitigated.

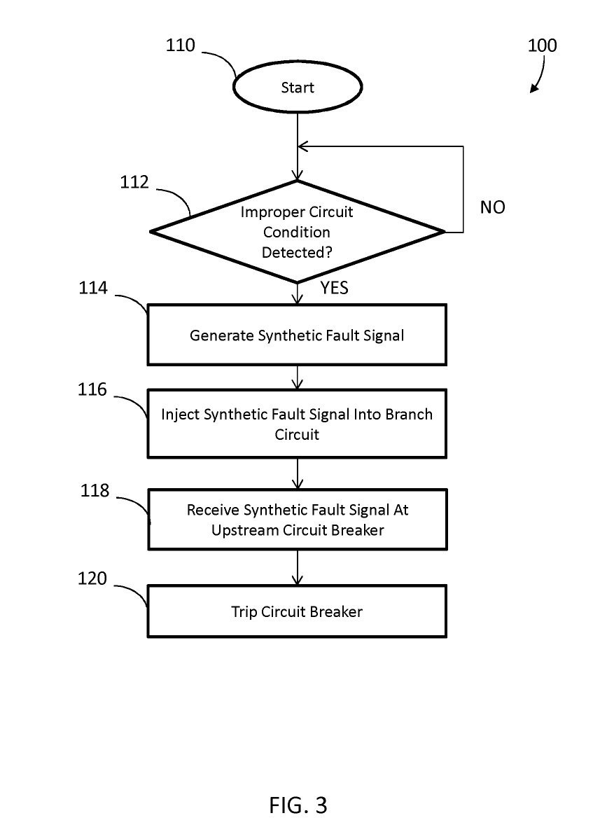

Referring now to FIG. 3, a flowchart of a process 100 for protecting a branch circuit 15 from improper circuit conditions that are not independently detected, detectable, or actionable by the electronic circuit breaker 18 is illustrated. The electrical device is remotely located downstream (e.g., on a branch circuit, a feeder circuit, etc.) relative to the upstream circuit breaker 18. At block 110, the process 100 is initiated. At decision block 112, it is determined whether one or more improper circuit conditions have been detected, for example, via one or more sensors 26 in, on, or proximate to the electrical device. If it is determined that an improper circuit condition has not been detected at block 112, the process 100 returns to the block 110.

If it is determined that an improper circuit condition has been detected at block 112, then a synthetic fault signal is generated (e.g., via a synthetic fault signal generator 24) at block 114. At block 116, the synthetic fault signal is provided to the upstream circuit breaker 18. For example, the synthetic fault signal can be injected onto a conductor(s) 16A, 16B on which electrical power is conducted between the upstream circuit breaker 18 and the downstream electrical device. At block 118, the synthetic fault signal is received by the upstream circuit breaker 18. At block 120, the upstream circuit breaker 18 determines that the synthetic fault signal is indicative of a circuit-breaker-trip condition and trips to remove electrical power from the downstream electrical device.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the scope of the invention as defined in the appended claims.

What is claimed is:

1. A synthetic fault signal generator assembly located on a branch circuit downstream of an electronic circuit breaker relative to an electrical power source, comprising:
a sensor configured to detect an improper circuit condition;
a synthetic fault signal generator communicatively coupled to the sensor, the synthetic fault signal generator being configured to generate and communicate a synthetic fault signal to the circuit breaker to cause the circuit breaker to trip in response to the sensor detecting the improper circuit condition.

2. The synthetic fault signal generator assembly of claim 1, wherein the improper circuit condition is not independently detected, detectable, or actionable by the circuit breaker.

3. The synthetic fault signal generator assembly of claim 1, wherein the circuit breaker is configured to trip in response to one or more circuit-breaker-trip conditions, the improper circuit condition being different from each of the one or more circuit-breaker-trip conditions, the synthetic fault signal mimicking one of the one or more circuit-breaker-trip conditions.

4. The synthetic fault signal generator assembly of claim 1, wherein the synthetic fault signal generator is configured to communicate the synthetic fault signal to the circuit breaker by injecting the synthetic fault signal into the branch circuit.

5. The synthetic fault signal generator assembly of claim 4, wherein the synthetic fault signal generator includes a switched shunt that is pulse-width modulated to generate and communicate the synthetic fault signal to the circuit breaker.

6. The synthetic fault signal generator assembly of claim 1, wherein the synthetic fault signal generator is located in, on, or proximate to a load.

7. The synthetic fault signal generator assembly of claim 6, wherein the load includes a power plug, the synthetic fault signal generator being located in the power plug.

8. The synthetic fault signal generator assembly of claim 1, wherein the synthetic fault signal generator is located in an outlet receptacle.

9. The synthetic fault signal generator assembly of claim 1, wherein the sensor is a thermal sensor and the improper circuit condition is an over-temperature condition.

10. The synthetic fault signal generator assembly of claim 1, wherein the sensor and the synthetic fault signal generator are located in a common housing.

11. A method of tripping an electronic circuit breaker, the electronic circuit breaker being configured to disconnect a load from an electrical power source in response to a circuit-breaker-trip condition, the method comprising:
detecting, via a synthetic fault signal generator assembly, an occurrence of an improper circuit condition, the synthetic fault signal generator assembly being remotely located downstream on a branch circuit relative to the circuit breaker, the improper circuit condition being not independently detected, detectable, or actionable by the circuit breaker;
generating a synthetic fault signal in response to the detection of the occurrence of the improper circuit condition, the generated synthetic fault signal having a signature indicative of the circuit-breaker-trip condition; and
providing the synthetic fault signal to the circuit breaker to cause the circuit breaker to trip.

12. The method of claim 11, wherein the providing the synthetic fault signal to the circuit breaker comprises injecting the synthetic fault signal onto a line conductor on which electrical power is conducted between the circuit breaker and the load.

13. The method of claim 11, wherein the signature of the synthetic fault signal includes spectral content in one or more frequency bands that the circuit breaker is configured to recognize as a fault signal indicative of the circuit-breaker-trip condition.

14. The method of claim 11, wherein the circuit breaker includes firmware, the method further comprising updating the firmware to configure the circuit breaker to detect the synthetic fault signal.

15. The method of claim 11, wherein the improper circuit condition associated with an outlet receptacle.

16. The method of claim 11, wherein detecting the occurrence of the improper load condition comprises determining whether a detected temperature is greater than a temperature-threshold value, a detected pressure is greater than a pressure-threshold value, a detected light intensity is greater than a light-intensity-threshold value, a detected liquid volume is greater than a liquid-volume-threshold value, or a detected sound intensity is greater than a sound-intensity-threshold value.

17. The method of claim 11, wherein the synthetic fault signal mimics a ground fault signal by creating a current imbalance on the branch circuit.

18. A system for protecting a load receiving power from an electrical power source, comprising:
an electronic circuit breaker electrically coupled to the electrical power source, the circuit breaker being configured to disconnect the load from the electrical power source in response to a predetermined circuit-breaker-trip condition; and
a synthetic fault signal generator electrically coupled to the circuit breaker, the synthetic fault signal generator being remotely located on a branch circuit downstream from the circuit breaker relative to the electrical power source, the synthetic fault signal generator being configured to detect an improper circuit condition that is not detected, detectable, or actionable by the circuit breaker, the synthetic fault signal generator being further configured to inject a synthetic fault signal into the branch circuit to cause the circuit breaker to disconnect the load from the electrical power source in response to the synthetic fault signal generator detecting the improper circuit condition, the synthetic fault signal being indicative of the circuit-breaker-trip condition.

19. The system of claim 18, wherein the circuit breaker is an arc-fault circuit interrupter.

20. The system of claim 18, wherein the circuit breaker is a ground fault interrupter.
